(19) United States
(12) Patent Application Publication
(10) Pub. No.: US 2025/0232211 A1
(43) Pub. Date: Jul. 17, 2025

(54) SYSTEMS AND METHODS FOR EVALUATING TRAINED MODELS

(71) Applicant: NOBLIS, INC., Reston, VA (US)

(72) Inventors: Adam Keith KOROBOW, Bristow, VA (US); Tyler Walsh BARRUS, Midlothian, VA (US); William Donald ERMLICK, Fairfax, VA (US); Mychal William Joseph IVANCICH, Reston, VA (US); Eric Gordon EPSTEIN, Herndon, VA (US); Talia Grace TURNHAM, Washington, DC (US); Paul-Sung HONG, Alexandria, VA (US)

(73) Assignee: NOBLIS, INC., Reston, VA (US)

(21) Appl. No.: 18/414,076

(22) Filed: Jan. 16, 2024

(51) Int. Cl. G06N 20/00

(52) U.S. Cl. CPC G06N 20/00

(57) ABSTRACT

A system for evaluating trained models comprises one or more processors configured to cause the system to: receive a trained model; receive test data comprising a plurality of data objects; receive baseline classification data assigning each data object to a class; apply one or more perturbation operations to the test data to generate, for each data object, a respective plurality of perturbed data objects; apply the trained model to each perturbed data object to generate post-perturbation classification data, wherein the post-perturbation classification data indicates classification of the respective perturbed data object into at least one class and an associated confidence level of the trained model with respect to the classification; determine, for each perturbed data object, whether the post-perturbation classification data indicates a misclassification as compared to the baseline classification data; and generate and display a visualization based on the determination of whether the post-perturbation classification data indicates a misclassification.

### FIELD

The present disclosure relates generally to systems and methods for model analysis and more specifically to systems and methods for evaluating trained models.

### BACKGROUND

After a computer model is developed and trained, it may be transitioned to a production environment where its robustness with respect to new data sets is unknown. The trained model's performance may be deficient in one or more ways when real data is used, even if the trained model performed satisfactorily when it was applied to training data. Deficiencies in trained model performance may include model biases, insufficient model accuracy, and/or insufficient model privacy. Because these deficiencies may not be sufficiently detectable during model building and/or model training, such deficiencies may not be detected until after the model has already been deployed. As a result, users may unknowingly receive and utilize inaccurate results from the trained model.

Furthermore, because performance of the trained model may not be monitored outside of the training environment, the trained model may be vulnerable to attacks that can go undetected. For instance, attackers may provide data to the trained model that is configured in such a way as to deceive or defeat the trained model. For example, object-detection models can be integrated into modern surveillance cameras, which can be prime targets for a host of adversarial attacks that are intended to prevent the trained model from detecting certain objects. If performance of the trained model in the production environment is not evaluated, these attacks may go undetected and succeed in causing the model to generate inaccurate results.

### SUMMARY

As described above, known systems for training and deploying computer models may not provide for sufficiently robust model evaluation, which may leave users vulnerable to deploying non-optimized models and may leave models vulnerable to attacks. Accordingly, there is a need for improved systems, methods, and techniques for model evaluation.

Described herein are systems, methods, electronic devices, non-transitory storage media, and apparatuses for evaluating trained models, which may address the above-identified need. The systems and methods described herein may allow a user to evaluate a trained model by applying the model to perturbed test data and determining whether the model's treatment of the perturbed test data was correct. A model evaluation system may receive a trained model and test data comprising a plurality of data objects, as well as baseline classification data assigning each data object to a class. The test data may be perturbed to create plurality of perturbed data objects. The trained model may then be applied to each of the perturbed data objects to generate post-perturbation classification data. By comparing the post-perturbation classification data to the baseline classification data, the model evaluation system can determine whether the trained model correctly classified the perturbed data objects and generate and display an indication of the results.

The techniques described herein provide several technical advantages. For example, the systems and methods described herein may expose weaknesses in a trained model by applying the trained model to perturbed data objects. The systems and methods provided may additionally provide instructions for automatically updating the trained model to improve its performance, for example by improving the model against weaknesses identified using one or more of the techniques described herein. This information may enable a user to better understand the trained model's behavior, including by understanding the model's robustness against different data perturbations and the model's areas of weakness. Understanding the model's strengths and weaknesses may allow users to alter the model, select use-cases in which to deploy the model, and/or better filter and understand model output data during deployment in order to achieve more accurate results using the trained model. Furthermore, the techniques described herein may improve the functioning of a computer. The model evaluation system may be used to automatically identify improvements to trained models that can be used to make the trained models run more accurately and efficiently, thereby reducing processing demands, computational demands, and/or power demands on computer systems executing the improved models.

In some embodiments, a system for evaluating trained models is provided, the system comprising one or more processors configured to cause the system to: receive a trained model; receive a set of test data comprising a plurality of data objects; receive baseline classification data that assigns each data object to a class of a plurality of classes; apply one or more perturbation operations to the test data to generate, for each of the data objects in the set of test data, a respective plurality of perturbed data objects; apply the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification; determine, for each of the perturbed data objects, whether the respective post-perturbation classification data indicates a misclassification as compared to the baseline classification data; and generate and display a visualization based on the determination of whether the post-perturbation classification data indicates a misclassification.

In some embodiments, the one or more processors are configured to cause the system to generate, based on the determination of whether the post-perturbation classification data indicates a misclassification, one or more instructions to update the trained model.

In some embodiments, the one or more instructions to update the trained model comprise an indication to a user that the trained model has failed robustness criteria, an indication of improvements to make to the trained model, or an indication to automatically generate training data for improving the trained model.

In some embodiments, the one or more processors are configured to cause the system to execute the one or more instructions to update the trained model.

In some embodiments, the one or more processors are configured to cause the system to: for the plurality of data objects assigned to the baseline classification data to a first class of the plurality of classes, wherein the plurality of data objects comprises a set of one or more images, define a plurality of spatial regions in the one or more images; calculate, for each spatial region, a respective perturbation importance score based on perturbations applied to the spatial region that caused misclassification; display a visual representation of an example image from the first class; and display a visual overlay over the example image indicating the perturbation importance score for one or more of the plurality of spatial regions.

In some embodiments, calculating, for each spatial region, a respective perturbation importance score comprises: applying a Gaussian blur to the respective spatial region; minimizing L2 Norm and total variational noise of perturbations applied to the respective spatial region; and determining a minimum level of perturbation intensity that caused misclassification.

In some embodiments, the one or more processors are configured to cause the system to: calculate, for each image in the set of one or more images, one or more respective feature importance scores based on perturbations applied to the image that changed one or more features of the image that caused misclassification; and generate and display a histogram indicating, for each image in the first class, the one or more feature importance scores.

In some embodiments, calculating, for each image in the set of one or more images, one or more respective feature importance scores comprises: generating an image pixel mask for the respective image; generating a salience pixel mask for the respective image; combining the image pixel mask and the salience pixel mask; and calculating one or more feature importance scores based on the combined image pixel mask and salience pixel mask.

In some embodiments, the one or more processors are configured to cause the system to: select a subset of post-perturbation classification data, wherein the subset of post-perturbation classification data corresponds to data objects assigned to a first class by the baseline classification data; and generate and display a visual representation indicating average class confidence levels generated by the trained model for the selected subset of data at various levels of perturbation intensity.

In some embodiments, displaying the visual representation indicating average class confidence levels comprises displaying a first indication of a first average class confidence level by which the trained model classified the perturbed data objects into the first class.

In some embodiments, displaying the first indication comprises: displaying a first region of the first indication at which average class confidence levels for the first class are highest compared to other classes; and simultaneously displaying a second region of the first indication at which average class confidence levels for the first class are not highest compared to other classes.

In some embodiments, displaying the visual representation indicating average class confidence levels comprises displaying a second indication of a second average class confidence level by which the trained model classified the perturbed data objects into a second class different from the first class.

In some embodiments, the second indication is displayed for levels of perturbation intensity at which class confidence level for the second class is higher than for any other class.

In some embodiments, the visual representation comprises a first line graph indicating average class confidence levels generated by the trained model at various levels of perturbation intensity.

In some embodiments, the first line graph comprises one or more lines corresponding to one or more classes of the plurality of classes.

In some embodiments, the one or more processors are configured to cause the system to: detect a user input comprising a selection of a first region visually indicating a first option to add to the first line graph one or more lines corresponding to one or more classes of the plurality of classes; and in response to detecting the user input, add the one or more lines to the first line graph.

In some embodiments, the one or more processors are configured to cause the system to: detect a user input comprising a selection of a second region visually indicating a second option to remove from the first line graph one or more lines corresponding to one or more classes of the plurality of classes; and in response to detecting the user input, remove the one or more lines from the first line graph.

In some embodiments, the one or more processors are configured to cause the system to: detect a user input comprising a selection of a region visually indicating a name of a class of the plurality of classes; and in response to detecting the user input, generate and display a second line graph indicating average class confidence levels of the trained model at various levels of perturbation intensity for the class; and generate and display a third line graph indicating associated confidence levels of the trained model at various levels of perturbation intensity for at least one data object in the class.

In some embodiments, a method for evaluating trained models is provided, the method comprising: receiving a trained model; receiving a set of test data comprising a plurality of data objects; receiving baseline classification data that assigns each data object to a class of a plurality of classes; applying one or more perturbation operations to the test data to generate, for each of the data objects in the set of test data, a respective plurality of perturbed data objects; applying the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification; determining, for each of the perturbed data objects, whether the respective post-perturbation classification data indicates a misclassification as compared to the baseline classification data; and generating and displaying a visualization based on the determination of whether the post-perturbation classification data indicates a misclassification.

In some embodiments, a non-transitory computer readable storage medium is provided, the non-transitory computer readable storage medium storing instructions that, when executed by one or more processors of an electronic device, cause the device to: receive a trained model; receive a set of test data comprising a plurality of data objects; receive baseline classification data that assigns each data object to a class of a plurality of classes; apply one or more perturbation operations to the test data to generate, for each of the data objects in the set of test data, a respective plurality of perturbed data objects; apply the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification; determine, for each of the perturbed data objects, whether the respective post-perturbation classification data indicates a misclassification as compared to the baseline classification data; and generate and display a visualization based on the determination of whether the post-perturbation classification data indicates a misclassification.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary system for evaluating trained models, according to some embodiments.

FIG. 2 illustrates an exemplary method for evaluating trained models, according to some embodiments.

FIG. 3 illustrates an exemplary method for evaluating trained models, according to some embodiments.

FIG. 4A illustrates a model confidence visualization, according to some embodiments.

FIG. 4B illustrates a multi-class model confidence visualization, according to some embodiments.

FIG. 4C illustrates a multi-class model confidence visualization, according to some embodiments.

FIG. 4D illustrates a class-specific model confidence visualization, according to some embodiments.

FIG. 4E illustrates a class-specific model confidence visualization, according to some embodiments.

FIG. 5 illustrates an exemplary method for evaluating trained models, according to some embodiments.

FIG. 6A illustrates a spatial region grid overlay on an example image from a class of images, according to some embodiments.

FIG. 6B illustrates a histogram indicating feature importance scores for a plurality of images in a class of images, according to some embodiments.

FIG. 7 shows a computer system, according to some embodiments.

### DETAILED DESCRIPTION

As described, it can be difficult to determine how trained models perform when exposed to new data sets outside of the training environment. A trained model may perform poorly when exposed to data that differs significantly from the training data, or it may be exposed to adversarial attacks specifically designed to undermine its performance.

Accordingly, provided herein are systems and methods for evaluating trained models. The described systems and methods involve receiving, at a model evaluation system, a trained model and test data comprising a plurality of data objects. The model evaluation system also receives baseline classification data assigning each data object to a class. The test data may then be perturbed to create plurality of perturbed data objects. The trained model can be applied to each of the perturbed data objects to generate post-perturbation classification data. By comparing the post-perturbation classification data to the baseline classification data, the model evaluation system can determine whether the trained model correctly classified the perturbed data objects and generate and display an indication of the results.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMS, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

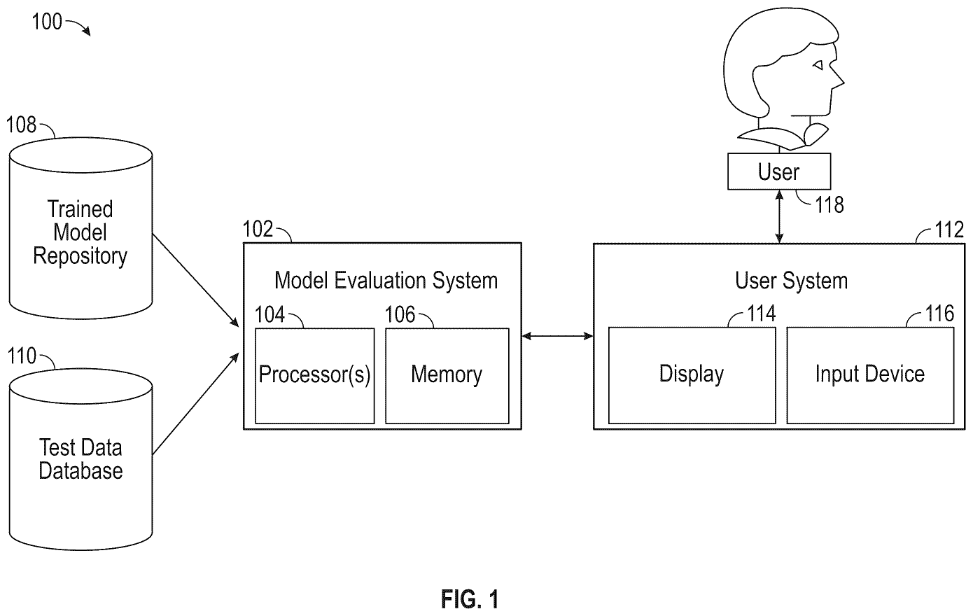

FIG. 1 illustrates an exemplary system 100 for evaluating trained models, according to some embodiments. As shown, system 100 may include a model evaluation system 102. Model evaluation system 102 may be a computer system comprising one or more processors 104 and at least one memory 106. Processor(s) 104 may include one or more processing units (e.g., digital circuitry, microcontrollers, microprocessors, embedded processors, central processing units (CPUs), graphics processing units (GPUs), etc.). Memory 106 may comprise any device configured to provide storage, including electrical, magnetic, or optical memory. For instance, memory 106 may include random-access memory (RAM), a cache, a hard drive, a CD-ROM drive, a tape drive, or a removable storage disk. Software comprising programs or instructions for evaluating trained models may be stored in memory 106 for execution by processor(s) 104.

Model evaluation system 102 may be coupled to a trained model repository 108. Processor(s) 104 of model evaluation system 102 may be configured to receive one or more trained models from trained model repository 108. The trained models in trained model repository 108 can include any type of model, including (but not limited to) image-based models, audio-based models, video-based models, text-based models, tabular models, or some combination thereof. Trained model repository 108 may comprise servers or databases that store models as well as storage devices such as USB drives, hard drives, or storage disks.

Model evaluation system 102 may also be coupled to test data database 110. Processor(s) 104 of model evaluation system 102 may be configured to receive test data from test data database 110. The test data in test data database 110 may include a plurality of data objects. The plurality of data objects in test data database 110 can include (but are not limited to) image files, audio files, audiovisual files, any written or otherwise text-based materials (e.g., Excel files, CSV files, JSON files, PDF files, word processor files, plain text files, rich text files, markup files), or some combination thereof. Additionally, test data database 110 may include baseline classification data that assigns each data object to a class of a plurality of classes. Test data database 110 may comprise servers or databases that store test data as well as storage devices such as USB drives, hard drives, or storage disks.

Processor(s) 104 of model evaluation system 102 may be configured to apply one or more perturbation operations to the test data received from test data database 110 and apply the trained model received from trained model repository 108 to generate post-perturbation classification data and determine whether the post-perturbation classification data indicates a misclassification. The determination of whether the post-perturbation classification data indicates a misclassification may be displayed to a user 118 via a display 114 of user system 112.

Processor(s) 104 of model evaluation system 102 may automatically receive trained models from trained model repository 108 and/or test data from test data database 110 in real time (e.g., as trained models are uploaded to trained model repository 108 and/or as test data is uploaded to test data database 110) or periodically (e.g., at predetermined times). Additionally, processor(s) 104 of model evaluation system 102 may be configured to request specific trained models from trained model repository 108 and/or specific test data from test data database 110, for example based on instructions received from user 118. Model evaluation system 102 may also be configured to receive trained models and/or test data via a manual upload by user 118.

Model evaluation system 102 may be configured to receive data from user system 112 indicating one or more inputs from a user 118. To facilitate the provision of information to and from user 118, model evaluation system 102 may be communicatively coupled to a user system 112. User system 112 may include a display 114 (e.g., a computer monitor or a screen) configured to be controlled by processor(s) 104. User system 112 may also include an input device 116 such as a keyboard, a mouse, or a touch sensor. After model evaluation system 102 determines whether post-perturbation data indicates a misclassification, the determination may be shown to user 118 via display 114 of user system 112. In some embodiments, user system 112 may further allow user 118 to interact with model evaluation system 102, such as to request that a specific trained model from trained model repository 108 be evaluated by model evaluation system 102 or to customize the visualization displayed on display 114.

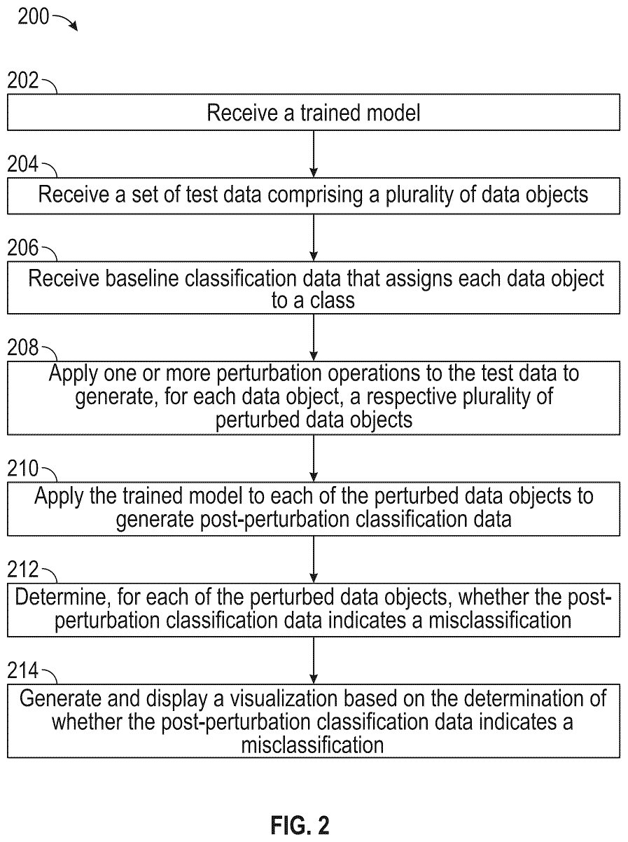

FIG. 2 illustrates an exemplary method 200 for evaluating trained models, according to some embodiments. Method 200 may be executed by any suitable system, such as model evaluation system 102 described above with reference to FIG. 1. The method 200 may be executed automatically, cither periodically or upon the occurrence of a predetermined condition (e.g., when an update is made to a trained model or when an update is made to the model evaluation system). Alternatively, the method 200 may be initiated by a user, for example via user system 112 described above with reference to FIG. 1. Method 200 is performed, for example, using one or more electronic devices implementing a software platform. In some examples, method 200 is performed using a client-server system, and the blocks of method 200 are divided up in any manner between the server and a client device. In other examples, the blocks of method 200 are divided up between the server and multiple client devices. In other examples, method 200 is performed using only a client device or only multiple client devices. In method 200, some blocks are, optionally, combined, the order of some blocks is, optionally, changed, and some blocks are, optionally, omitted. In some examples, additional steps may be performed in combination with the method 200. Accordingly, the operations as illustrated (and described in greater detail below) are exemplary by nature and, as such, should not be viewed as limiting.

The method 200 may begin at step 202, wherein step 202 includes receiving a trained model. The trained model may be retrieved from a trained model repository such as trained model repository 108 described above with reference to FIG. 1. The trained model may be any type of model, including (but not limited to) image analysis or image classification models, audio-based models, video-based models, text-based models, tabular models, or some combination thereof.

After receiving the trained model at step 202, the method 200 may proceed to step 204. Step 204 may include receiving a set of test data comprising a plurality of data objects. The test data may be retrieved from a test data database such as test data database 110 described above with reference to FIG. 1. The data objects in the test data may include any type of data object that can be processed by the trained model, including (but not limited to) images, text, audio files, audiovisual files, or some combination thereof.

The method 200 may proceed with step 206, wherein step 206 includes receiving baseline classification data that assigns each data object from the test data to a class of a plurality of classes. The plurality of classes may include any number or type of classes that can be used to categorize the data objects in the test data. For instance, if the test data comprises a plurality of images, the plurality of classes may correspond to a plurality of subjects depicted in the images.

After receiving the baseline classification data at step 206, the method 200 may proceed to step 208. Step 208 may include applying one or more perturbation operations to the test data to generate, for each data object, a respective plurality of perturbed data objects. The one or more perturbation operations may include any operations that alter the data objects. The type of perturbation operations applied to the test data may depend on the type of data objects comprising the test data. For instance, if the test data comprises a plurality of images, perturbation operations applied to the test data may include (but are not limited to) adjusting image brightness, adjusting image blur, adjusting image contrast, adjusting image hue, rotating the images, replacing one or more pixels, deleting one or more pixels, adding one or more pixels, adding white noise, adding colored noise, creating a compression artifact, performing an adversarial attack (e.g., an evasion attack, a data poisoning attack), performing a privacy attack, or any combination thereof. Similarly, if the test data comprises a plurality of text-based materials, perturbation operations may include replacing, inserting, or deleting characters; replacing, inserting, or deleting words; redacting portions of text; or creating translation errors.

The perturbed data objects generated in step 208 may include a respective plurality of perturbed data objects corresponding to each data object in the test data. A given type of perturbation operation may be conducted at various levels of perturbation intensity, resulting in a plurality of perturbed data objects corresponding to a single data object. For instance, a perturbation operation applied to test data comprising a plurality of images may include adjusting image brightness. Applying the image brightness perturbation to an image from the plurality of images may include applying the image brightness perturbation to the image at a first level of perturbation intensity and applying the image brightness perturbation to the same image at a second, different level of perturbation intensity. The plurality of perturbed data objects generated in step 208 may therefore include a respective plurality of perturbed images with various degrees of brightness corresponding to each image in the test data. The plurality of perturbed images may include a given image with the brightness turned down by 10%, the given image with the brightness turned down by 20%, the given image with the brightness turned up by 10%, the given image with the brightness turned up by 20%, etc.

After generating the plurality of perturbed data objects at step 208, the method 200 may proceed to step 210, wherein step 210 includes applying the trained model to each of the perturbed data objects to generate post-perturbation classification data. The post-perturbation classification data may indicate classification of each perturbed data object into at least one of the plurality of classes and an associated confidence level of the trained model with respect to the classification.

In some embodiments, the trained model may classify a given perturbed data object into a class for which the associated confidence level is the highest. An associated confidence level may indicate the confidence of the trained model that the perturbed data object belongs to a class from the plurality of classes. In some embodiments, an associated confidence level may be generated for a given perturbed data object with respect to each class from the plurality of classes. For instance, if there are N classes in the plurality of classes, N associated confidence levels may be generated for a given perturbed data object. A first associated confidence level may indicate the confidence of the trained model with respect to its classification of the perturbed data object into Class 1. A second associated confidence level may indicate the confidence of the trained model with respect to its classification of the perturbed data object into Class 2. An N^{th} associated confidence level may indicate the confidence of the trained model with respect to its classification of the perturbed data object into Class N. For a given perturbed data object, the class with the highest associated confidence level may be the predicted class. In some embodiments, the predicted class may align with the true class of the perturbed data object, wherein the true class is the class assigned to the data object corresponding to the perturbed data object by the baseline classification data. When the predicted class of a perturbed data object aligns with the true class of the perturbed data object, the trained model's classification is correct. In some embodiments, the predicted class may not align with the true class of the perturbed data object. When the predicted class of a perturbed data object does not align with the true class of the perturbed data object, the trained model's classification is incorrect.

In some embodiments, the trained model may classify a given perturbed data object into a class if the associated confidence level of the trained model with respect to the perturbed data object meets or exceeds a predefined threshold value. The predefined threshold value may be set automatically or may be selected by a user of the model evaluation system. For a given perturbed data object, the class or classes for which the associated confidence level of the trained model meets or exceeds the predefined threshold value may be the predicted class or classes. In some embodiments, a given perturbed data object may not be classified into a class if the associated confidence level of the trained model with respect to the perturbed data object is less than the predefined threshold value. In some embodiments, a given perturbed data object may be classified into one or more classes if the associated confidence level of the trained model meets or exceeds the predefined threshold value for one or more classes.

The method 200 may proceed to step 212, wherein step 212 comprises determining, for each of the perturbed data objects, whether the post-perturbation classification data indicates a misclassification as compared to the baseline classification data. A misclassification comprises a classification of a perturbed data object into a class by the trained model that is different from the class into which the perturbed data object was originally classified by the baseline classification data. The baseline classification data represents the ground truth classification information for each data object. As discussed above with reference to step 210, a misclassification occurs when the predicted class of a perturbed data object does not align with the true class of the perturbed data object.

At step 214, the method 200 may include generating and displaying a visualization based on the determination of whether the post-perturbation classification data indicates a misclassification. The visualization may be provided on a display such as display 114 of user system 112, as described above with reference to FIG. 1. In some embodiments, the visualization may comprise text, charts, tables, images, audio, video, or a combination thereof.

In some embodiments, the visualization includes one or more details of the misclassification. For example, the visualization may include, for each perturbed data object, an indication of the class assigned to the perturbed data object by the baseline classification data and an indication of the class or classes into which the perturbed data object was classified by the trained model. In some embodiments, this information can be indicative of a bias of the trained model toward a class of the plurality of classes.

In some embodiments, the visualization may comprise an indication of weaknesses in the trained model based on the determination of whether the post-perturbation classification data indicates a misclassification. The indication of weaknesses may include a natural language description of weaknesses in the model (e.g., the model may be particularly susceptible to inaccurate predictions under a certain kind of perturbation). The indication of weaknesses may also include one or more risk scores for the trained model based on one or more current risks posed by the trained model and/or a natural language description of the one or more current risks.

In some embodiments, the visualization may comprise one or more instructions to update the trained model. In some embodiments, after determining, for each of the perturbed data objects, whether the post-perturbation classification data indicates a misclassification as compared to the baseline classification data, one or more instructions to update the trained model may be generated based on the determination. In some embodiments, the one or more instructions may comprise an indication that the model has failed a predefined robustness criteria by exceeding a threshold number or proportion of misclassifications. The threshold number or proportion of misclassifications may be determined automatically or selected by a user. In some embodiments, the threshold number or proportion of misclassifications may correspond to trained model performance across all classes. For instance, a threshold number may be met if the trained model misclassifies more than the threshold number of data objects across all classes of data objects. In some embodiments, the threshold number or proportion of misclassifications may correspond to trained model performance with respect to one or more specific classes. For instance, a threshold number may be met if the trained model misclassifies more than the threshold number of data objects assigned to a specific class (e.g., Class N) by the baseline classification data. Using a class-specific threshold number or proportion of misclassifications may reveal one or more weaknesses of the trained model with respect to the one or more specific classes. Additionally, the one or more instructions may comprise an indication of improvements to be made to the model. For example, the one or more instructions may include an indication of improvements to the training process (e.g., to use differential privacy to train a model to better withstand privacy attacks). The one or more instructions may also comprise a machine-readable instruction for automatically (e.g., iteratively or recursively) improving or re-training the model.

In some embodiments, the one or more instructions to update the trained model may comprise an indication to generate or obtain training data to retrain the model. The training data may be based on the specific perturbations that caused the model to misclassify. In some embodiments, the training data may comprise the plurality of perturbed data objects generated in step 208. In some embodiments, the model evaluation system may be configured to generate additional perturbed data objects for training. Additionally, the model evaluation system may be configured to generate data for training the model to withstand adversarial attacks. For instance, the training data may comprise a plurality of data objects intended to deceive the trained model. The plurality of data objects may include data objects from one or more adversarial attacks (e.g., perturbed adversarial data objects), such that the model, once trained on the data, is not deceived by the one or more adversarial attacks. Furthermore, the model evaluation system may be configured to generate data for training the model to withstand privacy attacks (e.g., data intended to provoke the trained model to reveal information about the structure of the trained model or the training data used to train the model). For example, the model evaluation system may inject a surrogate class into a target class with random mislabeling to mitigate model inversion. In another example, the model evaluation system may augment or modify a data set such that when the data set is used to train a model, the trained model only reveals information from a public data set.

In some embodiments, a user may request via a user system, such as user system 112 as described with reference to FIG. 1 above, that the model evaluation system execute the one or more instructions or a portion thereof. For example, the user system may include an interactive graphical user interface, wherein a user may select an option to update the trained model (e.g., an option to retrain the trained model based on a suggested technique proposed by the model evaluation system). In some embodiments, the one or more instructions or a portion thereof may be automatically executed by one or more processors of the model evaluation system, such as processor(s) 104 of model evaluation system 102 as described above with reference to FIG. 1.

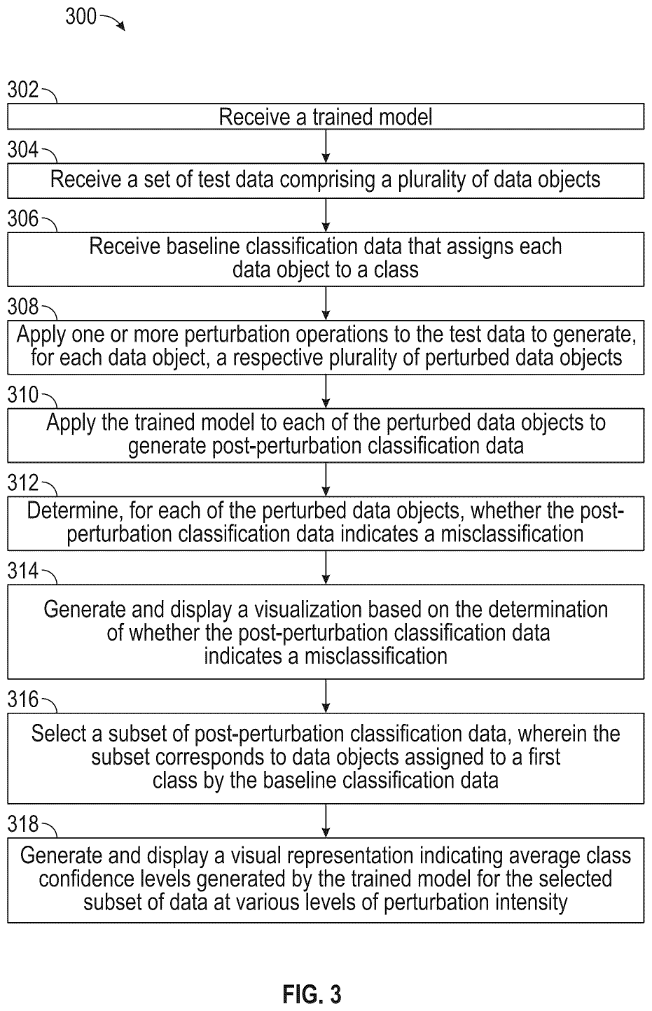

FIG. 3 illustrates an exemplary method 300 for evaluating trained models, according to some embodiments. Method 300 is performed, for example, using one or more electronic devices implementing a software platform. In some examples, method 300 is performed using a client-server system, and the blocks of method 300 are divided up in any manner between the server and a client device. In other examples, the blocks of method 300 are divided up between the server and multiple client devices. In other examples, method 300 is performed using only a client device or only multiple client devices. In method 300, some blocks are, optionally, combined, the order of some blocks is, optionally, changed, and some blocks are, optionally, omitted. In some examples, additional steps may be performed in combination with the method 300. Accordingly, the operations as illustrated (and described in greater detail below) are exemplary by nature and, as such, should not be viewed as limiting.

The method 300 may begin at step 302, wherein step 302 includes receiving a trained model. Step 302 may share any one or more characteristics with step 202 as described above with reference to FIG. 2.

After receiving the trained model, the method 300 may proceed to step 304, wherein step 304 may include receiving a set of test data comprising a plurality of data objects. Step 304 may share any one or more characteristics with step 204 as described above with reference to FIG. 2.

The method 300 may proceed to step 306. Step 306 may include includes receiving baseline classification data that assigns each data object from the test data to a class of a plurality of classes. Step 306 may share any one or more characteristics with step 206 as described above with reference to FIG. 2.

At step 308, the method 300 may include applying one or more perturbation operations to the test data to generate, for each data object, a respective plurality of perturbed data objects. Step 308 may share any one or more characteristics with step 208 as described above with reference to FIG. 2.

The method 300 may proceed to step 310, wherein step 310 may include applying the trained model to each of the perturbed data objects to generate post-perturbation classification data. The post-perturbation classification data may indicate classification of the respective perturbed data object into at least one of the plurality of classes and an associated confidence level of the trained model with respect to the classification. Step 310 may share any one or more characteristics with step 210 as described above with reference to FIG. 2.

After applying the trained model to each of the perturbed data objects to generate post-perturbation classification data, the method 300 may proceed to step 312. Step 312 may include determining, for each of the perturbed data objects, whether the post-perturbation classification data indicates a misclassification as compared to the baseline classification data. Step 312 may share any one or more characteristics with step 212 as described above with reference to FIG. 2.

After determining, for each of the perturbed data objects, whether the post-perturbation classification data indicates a misclassification as compared to the baseline classification data, the method 300 may proceed to step 314. Step 314 may include generating and displaying a visualization based on the determination of whether the post-perturbation classification data indicates a misclassification. Step 314 may share any one or more characteristics with step 214 as described above with reference to FIG. 2.

In some embodiments, the method 300 may proceed to step 316, wherein step 316 may comprise selecting a subset of post-perturbation classification data. The subset of post-perturbation classification data may correspond to one or more perturbed data objects that were assigned to a first class by the baseline classification data. For instance, for test data comprising a plurality of images, the subset of post-perturbation classification data may include one or more images assigned to the class “baton” by the baseline classification data, as well as the trained model classifications and associated confidence levels corresponding to those images.

After selecting a subset of post-perturbation classification data, the method 300 may proceed to step 318. Step 318 may include generating and displaying a visual representation indicating average class confidence levels generated by the trained model for the selected subset of data at various levels of perturbation intensity. In some embodiments, the average class confidence levels generated by the trained model may comprise averages of the associated confidence levels generated by the trained model with respect to the classification of each of the perturbed data objects in step 310.

In some embodiments, the visual representation comprises a line graph indicating average class confidence levels generated by the trained model at various levels of perturbation intensity. The line graph may include one or more lines corresponding to one or more classes of the plurality of classes.

In some embodiments, the visual representation may comprise a line graph indicating average true class confidence levels. As discussed above with reference to step 210 of FIG. 2, the true class of a given perturbed data object is the class assigned by the baseline classification data to the data object corresponding to the perturbed data object. Thus, an average true class confidence level indicates the average confidence of the trained model that perturbed data objects belonging to a true class actually belong to that true class.

In some embodiments, the line graph indicating average true class confidence levels comprises a first region at which average class confidence levels for the true class are highest compared to other classes and a second region at which average class confidence levels for the true class are not highest compared to other classes. The first region corresponds to perturbation intensities at which the trained model, on average, correctly classified the perturbed data objects into the same class as the class assigned to the perturbed data objects by the baseline classification data. The second region corresponds to perturbation intensities at which the trained model, on average, incorrectly classified the perturbed data objects into a different class than the class assigned to the perturbed data objects by the baseline classification data.

In some embodiments, the first region may comprise a solid line on the line graph. In some embodiments, the second region may comprise a dashed line on the line graph. In some embodiments, the first region may include a label indicating that the trained model classification was correct at the perturbation intensities corresponding to the first region. In some embodiments, the second region may include a label indicating that the trained model classification was incorrect at the perturbation intensities corresponding to the second region.

In some embodiments, the visual representation may comprise a line graph indicating average predicted class confidence levels. As discussed above with reference to step 210 of FIG. 2, the predicted class of a given perturbed data object is the class with the highest associated confidence level. Thus, an average predicted class confidence level indicates the confidence of the trained model that perturbed data objects in a class belong to the class for which the trained model had the highest associated confidence levels on average. In some embodiments, the class with the highest associated confidence levels may be the true class. In some embodiments, the class with the highest associated confidence levels may not be the true class. In some embodiments, the line graph indicating average predicted class confidence comprises a first region corresponding to perturbation intensities at which the trained model, on average, correctly classified the perturbed data objects into the true class and a second region corresponding to perturbation intensities at which the trained model, on average, incorrectly classified the perturbed data objects into a different class other than the true class. In some embodiments, the first region may comprise a solid line on the line graph. In some embodiments, the second region may comprise a dashed line on the line graph. In some embodiments, the first region may include a label indicating that the trained model classification was correct at the perturbation intensities corresponding to the first region. In some embodiments, the second region may include a label indicating that the trained model classification was incorrect at the perturbation intensities corresponding to the second region.

In some embodiments, the model evaluation system may be configured to allow a user to interact with the visual representation. In some embodiments, where the visual representation includes a line graph indicating average class confidence levels generated by the trained model at various levels of perturbation intensity, the model evaluation system may be configured to detect a user input comprising a selection of an option (e.g., an item on a drop-down menu) to add to the line graph one or more lines corresponding to one or more classes of the plurality of classes. In response to detecting the user input, the one or more lines may be added to the line graph.

In some embodiments, the model evaluation system may be configured to detect a user input comprising a selection of an option (e.g., an item on a drop-down menu) to remove from the line graph one or more lines corresponding to one or more classes of the plurality of classes. In response to detecting the user input, the one or more lines may be removed from the line graph.

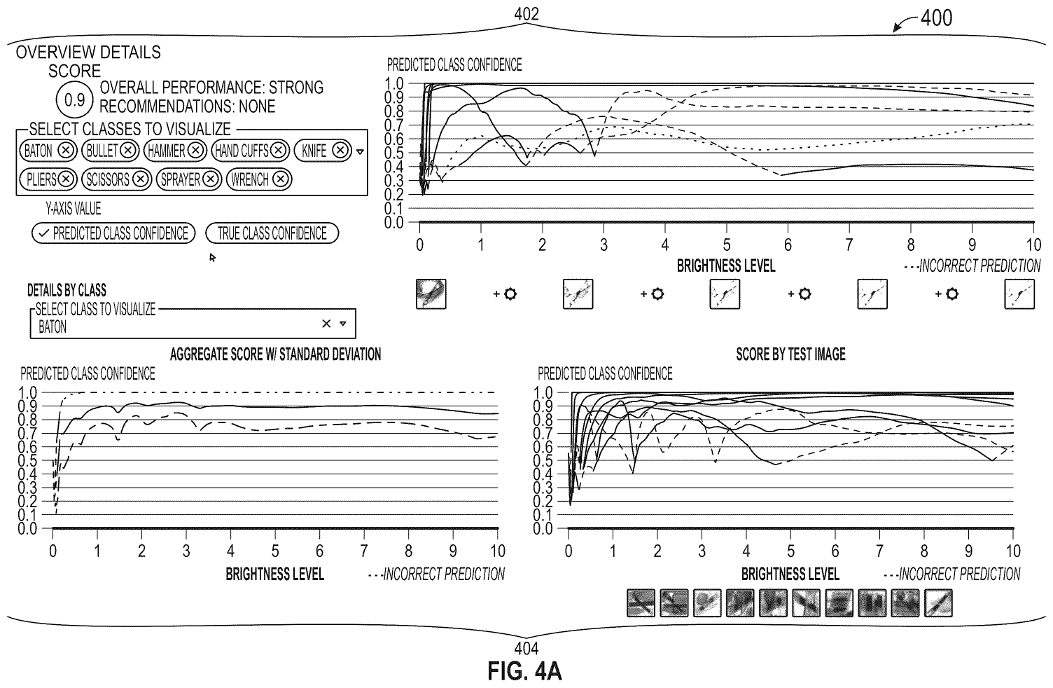

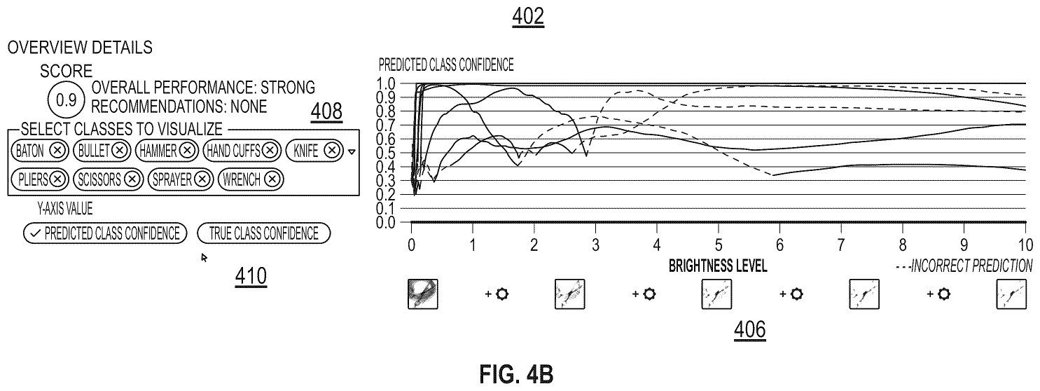

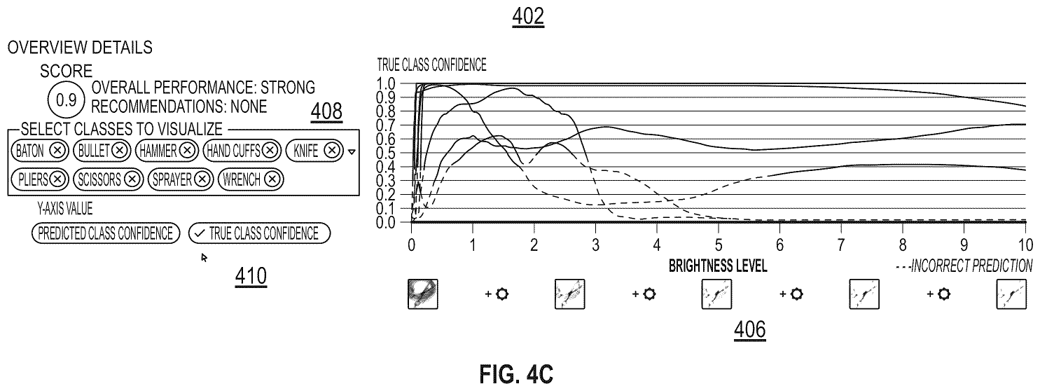

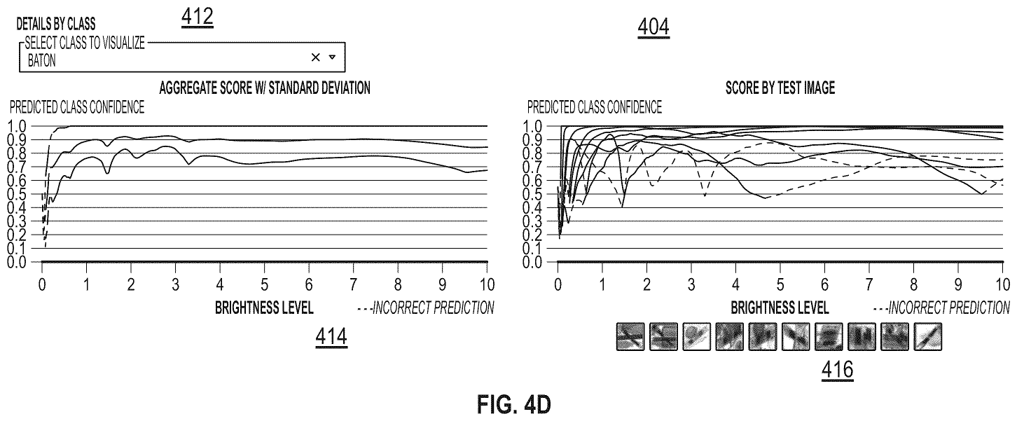

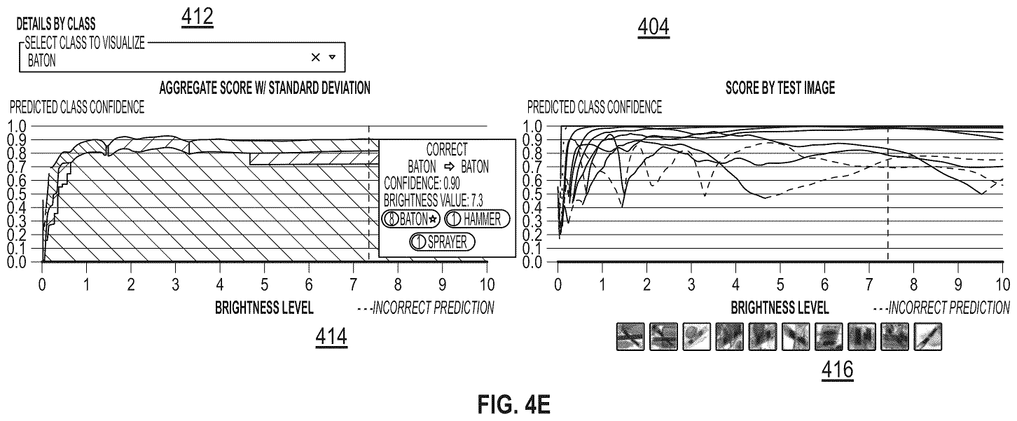

In some embodiments, the model evaluation system may be configured to detect a user input comprising a selection of a region visually indicating a name of a class of the plurality of classes. In response to detecting the user input, the system may generate and display two additional line graphs in addition to the line graph indicating average class confidence levels generated by the trained model at various levels of perturbation intensity. The first additional line graph may indicate average class confidence levels of the trained model at various levels of perturbation intensity for the selected class only. The second additional line graph may indicate associated confidence levels of the trained model at various levels of perturbation intensity for at least one data object in the selected class. In some embodiments, all three line graphs may be provided in a single visual representation, as shown in FIG. 4A.

FIG. 4A illustrates a model confidence visualization 400, according to some embodiments. The model confidence visualization 400 may be generated, for example, by method 300 described above with reference to FIG. 3.

As shown in FIG. 4A, model confidence visualization 400 may include a multi-class model confidence visualization 402 and a class-specific model confidence visualization 404. In some embodiments, multi-class model confidence visualization 402 may include a line graph indicating average class confidence levels generated by the trained model at various levels of perturbation intensity for a plurality of classes. Multi-class model confidence visualization 402 may include the line graph indicating average true class confidence levels or the line graph indicating average predicted class confidence levels discussed above with reference to step 318 of FIG. 3. The line graph shown in multi-class model confidence visualization 402 may include one or more lines corresponding to one or more classes from a plurality of classes. For example, multi-class model confidence visualization 402 as shown in FIG. 4A displays average class confidence levels for a plurality of classes of images (e.g., baton, bullet, hammer, handcuffs, knife, pliers, scissors, sprayer, wrench). A line on multi-class model confidence visualization 402 corresponding to the class “knives” may therefore indicate average class confidence levels of the trained model with respect to its classification of perturbed data objects assigned to the class “knives” by the baseline classification data. The average class confidence levels shown in multi-class model confidence visualization 402 can be true class confidence levels or predicted class confidence levels. A true class confidence level indicates the confidence of the trained model in its classification of a perturbed data object into the class assigned by the baseline classification data to the data object corresponding to the perturbed data object. A predicted class confidence level indicates the confidence of the trained model in its classification of a perturbed data object into a class for which the trained model had the highest confidence, regardless of whether the predicted class was the true class or not. Each line shown on multi-class model confidence visualization 402 may also indicate whether the trained model was correct, on average, in its classification of a set of data objects assigned to a class based on the baseline classification data. For instance, as shown in FIG. 4A, correct classifications by the trained model may be shown on the line graph by a solid line, while incorrect classifications by the trained model may be shown on the line graph by a dashed line.

In some embodiments, class-specific model confidence visualization 404 may include a line graph indicating average class confidence levels generated by the trained model at various levels of perturbation intensity for a selected class as well as a line graph indicating data object-specific confidence levels generated by the trained model at various levels of perturbation intensity for a plurality of data objects in the selected class. Class-specific model confidence visualization 404 may include the two additional line graphs discussed above with reference to step 318 of FIG. 3. In some embodiments, model confidence visualization 400 may be configured to allow a user to select a single class for which class-specific model confidence visualization 404 may be displayed. The single class may be any class selected from the plurality of classes included in multi-class model confidence visualization 402. When a single class is selected, the two line graphs in single-class model confidence visualization 404 may populate with data corresponding to the selected class. A first line graph, shown on the left side of single-class model confidence visualization 404, may show average confidence levels generated by the trained model at various levels of perturbation intensity for the selected class only. For example, as shown in FIG. 4A, the first line graph displays average class confidence levels for the “baton” class only. The first line graph may also include a curve displaying the standard deviation for the selected class. A second line graph, shown on the right side of single-class model confidence visualization 404, may show data object-specific confidence levels for data objects belonging to the selected class. The second line graph may include a plurality of lines corresponding to a plurality of data objects in the selected class. For example, as shown in FIG. 4A, the second line graph displays image-specific confidence levels for ten images belonging to the “baton” class.

In some embodiments, model confidence visualization 400 may include additional information about trained model performance, such as one or more overall performance metrics or one or more recommendations to update the trained model. For instance, in FIG. 4A, model confidence visualization 400 includes a numerical overall performance score of 0.9, a qualitative overall performance score of strong, and a recommendation that no updates be made to the trained model.

FIG. 4B illustrates a multi-class model confidence visualization 402, according to some embodiments. Multi-class model confidence visualization 402 may be included in model confidence visualization 400. Multi-class model confidence visualization 402 may include multi-class average confidence line graph 406, class selection functionality 408, and confidence type selection functionality 410. Multi-class average confidence line graph 406 may be a line graph indicating average class confidence levels generated by the trained model at various levels of perturbation intensity for a plurality of classes. In some embodiments, each line on multi-class average confidence line graph 406 may represent a different class of the plurality of classes. Each line may represent an average of the confidence levels of the trained model with respect to its classification of the data object. In some embodiments, multi-class average confidence line graph 406 may also indicate whether the trained model's classification was correct or incorrect at each level of perturbation intensity. In some embodiments, a correct classification may be indicated by a solid line on multi-class average confidence line graph 406, while an incorrect classification may be indicated by a dashed line on multi-class average confidence line graph 406.

Multi-class model confidence visualization 402 may also include class selection functionality 408. In some embodiments, the model evaluation system may be configured to allow a user to use class selection functionality 408 to select classes to display or remove from multi-class average confidence line graph 406. For instance, in FIG. 4B, class selection functionality 408 includes a plurality of class names displayed on multi-class average confidence line graph 406. In response to detecting a user selection of a name of a class, the model evaluation system may be configured to remove the selected class from multi-class average confidence line graph 406. Alternatively, a class may be added to multi-class average confidence line graph 406 by selecting the name of the desired class.

Additionally, multi-class model confidence visualization 402 may include a confidence type selection functionality 410. The model evaluation system may be configured to allow a user to use confidence type selection functionality 410 to select a type of confidence value to be shown on the y-axis of multi-class average confidence line graph 406. For instance, the confidence value shown may comprise a predicted class confidence value or a true class confidence value.

FIG. 4B shows an embodiment in which predicted class confidence is selected on confidence type selection functionality 410. Predicted class confidence is, for a given data object, the confidence of the trained model that the data object belongs to a class from the plurality of classes, regardless of whether that classification is correct. The predicted class determined by the trained model is the class for which the trained model's confidence level is highest as compared to other classes. Average predicted class confidence, which is shown in multi-class average confidence line graph 406, therefore represents the average of the predicted class confidence values for each data object assigned to the class by the baseline classification data. For instance, for a set of images indicated as scissors by the baseline classification data, if a trained model classified the images instead as knives, the predicted class confidence would indicate what the confidence of the trained model was in its classification of the images as knives, not what its (lower) confidence was with respect to scissors. In addition, the predicted class confidence curve shown by multi-class confidence line graph 406 may indicate whether the trained model's classification was correct at various levels of perturbation intensity for each class shown on multi-class confidence line graph 406. At levels of perturbation intensity at which the trained model's classification was correct for a class of images, the predicted class confidence line corresponding to the class may be a solid line. At levels of perturbation intensity at which the trained model's classification was incorrect for a class of images, the predicted class confidence line corresponding to the class may be a dashed line. For example, in FIG. 4B, the line representing knives on multi-class confidence line graph 406 is solid, indicating a correct prediction, until a perturbation intensity level of approximately 1.8, at which point the line representing knives becomes dashed, indicating an incorrect prediction. At a perturbation intensity level of approximately 5.9, the line representing knives becomes solid again, indicating a correct prediction at levels of perturbation intensity above approximately 5.9.

FIG. 4C illustrates a multi-class model confidence visualization 402, according to some embodiments. As discussed above with reference to FIG. 4B, multi-class model confidence visualization 402 may be included in model confidence visualization 400. Multi-class model confidence visualization 402 may include multi-class average confidence line graph 406, class selection functionality 408, and confidence type selection functionality 410.

FIG. 4C shows an embodiment in which true class confidence is selected on confidence type selection functionality 410. True class confidence is, for a given data object, the confidence of the trained model that the data object belongs to the class to which the data object was assigned by the baseline classification data (i.e., its true class). For instance, if a trained model classified a set of images that were classified as scissors by the baseline classification data as knives, the true class confidence would indicate what the confidence of the trained model was in its classification of the images as scissors, not what its confidence was with respect to knives. In addition, the true class confidence curve shown by multi-class confidence line graph 406 may indicate whether the trained model's classification was correct at various levels of perturbation intensity for each class shown on multi-class confidence line graph 406. At levels of perturbation intensity at which the trained model correctly classified the images from a given class into their true class, the true class confidence line corresponding to the class may be a solid line. At levels of perturbation intensity at which the trained model incorrectly classified the images from a given class into a class other than their true class, the true class confidence line corresponding to the class may be a dashed line. For example, in FIG. 4C, the line representing knives on multi-class confidence line graph 406 is solid, indicating a correct prediction, until a perturbation intensity level of approximately 1.8, at which point the line representing knives becomes dashed, indicating an incorrect prediction. At a perturbation intensity level of approximately 5.9, the line representing knives becomes solid again, indicating a correct prediction at levels of perturbation intensity above approximately 5.9. The portion of the line that is dashed in FIG. 4C is a concave-up curve, while the same portion is a concave-down curve in FIG. 4B. The concavities of the curves corresponding to the dashed portions of FIGS. 4B and 4C are inverted because at that range of perturbation intensities, the trained model was more confident in its classification of the images of knives into a class other than knives (resulting in a high predicted class confidence value in that region of FIG. 4B) than it was in its classification of the images of knives into their true class (resulting in a low true class confidence value in the corresponding region of FIG. 4C).

FIG. 4D illustrates a class-specific model confidence visualization 404, according to some embodiments. Class-specific model confidence visualization 404 may be included in model confidence visualization 400. Class-specific model confidence visualization 404 may include single class selection functionality 412, single class average confidence line graph 414, and data object-specific confidence line graph 416.

In some embodiments, the model evaluation system may be configured to allow a user to use single class selection functionality 412 to select a single class for which to display data in single class average confidence line graph 414 and data object-specific confidence line graph 416. In some embodiments, single class selection functionality 412 may comprise a drop-down menu of options comprising the names of the plurality of classes.

In some embodiments, single class average confidence line graph 414 indicates average class confidence levels generated by the trained model at various levels of perturbation intensity for the single class indicated by single class selection functionality 412. The average class confidence levels shown for the single class may be predicted class confidence levels or true class confidence levels, as discussed above with reference to FIGS. 4B and 4C. In some embodiments, a correct classification may be indicated by a solid line on single class average confidence line graph 414, while an incorrect classification may be indicated by a dashed line on single class average confidence line graph 414. In some embodiments, single class average confidence line graph 414 may include one or more lines depicting standard deviation. For example, as shown in FIG. 4D, single class average confidence line graph 414 includes, for the class “baton”, one line indicating average class confidence levels, one line indicating one standard deviation above the average class confidence levels, and one line indicating one standard deviation below the average class confidence levels.

In some embodiments, single class average confidence line graph 414 may populate with additional information when a cursor is hovered over the average confidence curve and/or an area under the average confidence curve. For instance, single class average confidence line graph 414 may display, in the area under the curve corresponding to average class confidence, the average confidence of the trained model with respect to each class predicted by the trained model at various levels of perturbation intensity. In some embodiments, hovering a cursor over the average confidence curve and/or an area under the average confidence curve may also cause the system to display a text indication of the classes predicted by the trained model at various levels of perturbation intensity. The text indication may additionally include whether classification by the trained model was correct or incorrect and what the trained model's corresponding numerical confidence level was at various levels of perturbation intensity. These additional features are shown in FIG. 4E described below.

In some embodiments, data object-specific confidence line graph 416 indicates associated confidence levels generated by the trained model at various levels of perturbation intensity for at least one data object in the single class. In some embodiments, data object-specific confidence line graph 416 may include a plurality of lines corresponding to a plurality of data objects in the single class. For instance, in FIG. 4D, data object-specific confidence levels are shown for ten images in the single class (e.g., baton). In some embodiments, a correct classification may be indicated by a solid line on data object-specific confidence line graph 416, while an incorrect classification may be indicated by a dashed line on data object-specific confidence line graph 416.

In some embodiments, data object-specific confidence line graph 416 may populate with additional information when a cursor is hovered over a line corresponding to a specific data object. The additional information may be displayed as a text indication overlaid on data object-specific confidence line graph 416. The text indication may include, for the specific data object, the name of each class for which the trained model had a nonzero confidence level at the level of perturbation intensity at which the cursor is hovered. For example, if a cursor is hovered over a line corresponding to a first image of a baton at a perturbation intensity of 2, a text indication may populate and indicate one or more classes for which the trained model had a nonzero confidence level at a perturbation intensity of 2 (e.g., baton, hammer, sprayer). The text indication may further include the confidence level of the trained model with respect to each class. This information may be useful in determining common misclassifications and/or model biases.

FIG. 4E illustrates a class-specific model confidence visualization 404, according to some embodiments. As described above with reference to FIG. 4D, class-specific model confidence visualization 404 may be included in model confidence visualization 400 and may include single class selection functionality 412, single class average confidence line graph 414, and data object-specific confidence line graph 416. As shown in FIG. 4E, single class average confidence line graph 414 can include additional information when a cursor is hovered over the average confidence curve and/or an area under the average confidence curve.

Single class average confidence line graph 414 may populate with additional information when a cursor is hovered over the average confidence curve and/or an area under the average confidence curve. Single class average confidence line graph 414 may display, in the area under the curve corresponding to average class confidence, the average confidence of the trained model with respect to each class predicted by the trained model at various levels of perturbation intensity. For example, as shown in FIG. 4E, when “baton” is selected using single class selection functionality 412, single class average confidence line graph 414 shows average confidence for the class “baton”. When a cursor is hovered over the “baton” average confidence curve and/or an area under the “baton” average confidence curve, the area under the curve may be shaded or otherwise filled in to indicate the average confidence of the trained model with respect to each class predicted by the trained model at various levels of perturbation intensity (e.g., baton, hammer, sprayer). Hovering the cursor also causes a text indication of the classes predicted by the trained model at various levels of perturbation intensity to appear on single class average confidence line graph 414. The text indication includes whether the classification by the trained model was correct or incorrect, the trained model's corresponding numerical confidence level, and the classes predicted by the trained model at the level of perturbation intensity at which the cursor is hovered. The indication of the classes predicted by the trained model at the level of perturbation intensity at which the cursor is hovered may include the number of perturbed images predicted to belong to each class by the trained model at that level of perturbation intensity. For example, as shown in FIG. 4E, at a perturbation intensity level of 7.3, the trained model correctly predicted that eight images of batons belonged to the class “baton” and incorrectly predicted that one image of a baton belonged to the class “hammer” and one image of a baton belonged to the class “sprayer”.

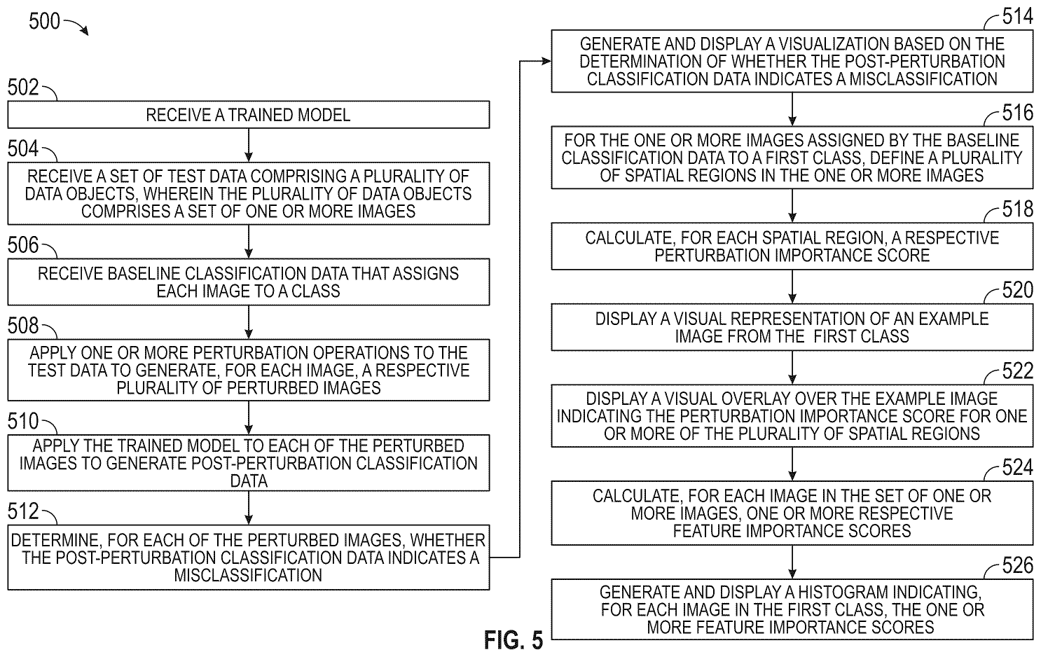

FIG. 5 illustrates an exemplary method 500 for evaluating trained models, according to some embodiments. Method 500 is performed, for example, using one or more electronic devices implementing a software platform. In some examples, method 500 is performed using a client-server system, and the blocks of method 500 are divided up in any manner between the server and a client device. In other examples, the blocks of method 500 are divided up between the server and multiple client devices. In other examples, method 500 is performed using only a client device or only multiple client devices. In method 500, some blocks are, optionally, combined, the order of some blocks is, optionally, changed, and some blocks are, optionally, omitted. In some examples, additional steps may be performed in combination with the method 500. Accordingly, the operations as illustrated (and described in greater detail below) are exemplary by nature and, as such, should not be viewed as limiting.

The method 500 may begin at step 502, wherein step 502 includes receiving a trained model. Step 502 may share any one or more characteristics with steps 202 or 302 as described above with reference to FIG. 2 or 3.

After receiving the trained model, the method 500 may proceed to step 504, wherein step 504 may include receiving a set of test data comprising a plurality of data objects, wherein the plurality of data objects comprises a set of one or more images. Step 504 may share any one or more characteristics with steps 204 or 304 as described above with reference to FIG. 2 or 3.

The method 500 may proceed to step 506. Step 506 may include includes receiving baseline classification data that assigns each image from the test data to a class of a plurality of classes. Step 506 may share any one or more characteristics with steps 206 or 306 as described above with reference to FIG. 2 or 3.

At step 508, the method 500 may include applying one or more perturbation operations to the test data to generate, for each image, a respective plurality of perturbed images. Step 508 may share any one or more characteristics with steps 208 or 308 as described above with reference to FIG. 2 or 3.

The method 500 may proceed to step 510, wherein step 510 may include applying the trained model to each of the perturbed images to generate post-perturbation classification data. The post-perturbation classification data may indicate classification of the respective perturbed image into at least one of the plurality of classes and an associated confidence level of the trained model with respect to the classification. Step 510 may share any one or more characteristics with steps 210 or 310 as described above with reference to FIG. 2 or 3.

After applying the trained model to each of the perturbed data objects to generate post-perturbation classification data, the method 500 may proceed to step 512. Step 512 may include determining, for each of the perturbed images, whether the post-perturbation classification data indicates a misclassification as compared to the baseline classification data. Step 512 may share any one or more characteristics with steps 212 or 312 as described above with reference to FIG. 2 or 3.

After determining, for each of the perturbed data objects, whether the post-perturbation classification data indicates a misclassification as compared to the baseline classification data, the method 500 may proceed to step 514. Step 514 may include generating and displaying a visualization based on the determination of whether the post-perturbation classification data indicates a misclassification. Step 514 may share any one or more characteristics with steps 214 or 314 as described above with reference to FIG. 2 or 3.

The method 500 may proceed to step 516, wherein step 516 includes defining, for the one or more images assigned by the baseline classification data to a first class, a plurality of spatial regions in the one or more images. In some embodiments, the spatial regions may be uniformly sized, shaped, and spaced, for example in cases in which an image is divided into a grid of square or rectangular patches. In some embodiments, spatial regions may be irregularly sized, shaped, and/or spaced. In some embodiments, one or more transformation operations (e.g., rotating, zooming in or out) are applied to the one or more images to standardize one or more aspects of the images (e.g., orientation, size) before defining the spatial regions.

After defining a plurality of spatial regions in the one or more images, the method 500 may proceed to step 518. Step 518 may comprise calculating, for each spatial region, a respective perturbation importance score. The perturbation importance score for each spatial region may be an aggregate perturbation importance score for the respective spatial region in each image in the set of one or more images. In some embodiments, the perturbation importance score for a spatial region is based on the number of perturbations in the respective spatial region that caused misclassification. The perturbation importance score may be weighted such that smaller perturbations that cause misclassification are assigned greater significance than larger perturbations that cause misclassification. In some embodiments, the perturbation importance score for a spatial region is calculated using the Randomized Input Sampling for Explanation (RISE) algorithm. In some embodiments, the perturbation importance score for a spatial region of a given image is calculated by applying a Gaussian blur to a masked region of the image corresponding to the respective spatial region. The masked region may comprise all or part of the respective spatial region. The L2 Norm and total variational noise of the perturbations applied to the masked region are minimized. The perturbation score is obtained by determining the minimum level of perturbation intensity required to generate a misclassification.

After calculating a respective perturbation importance score for each spatial region, the method 500 may proceed to step 520, wherein step 520 may include displaying a visual representation of an example image from the first class. The example image may be any image assigned to the first class by the baseline classification data.

The method 500 may then proceed to step 522. Step 522 may include displaying a visual overlay over the example image indicating the perturbation importance score for one or more spatial regions of the plurality of spatial regions. In some embodiments, the visual overlay may indicate the spatial regions defined in step 516. The spatial regions may be indicated using shading and/or coloring overlaid on the portions of the example image corresponding to the spatial regions, or the boundaries of the spatial regions may be outlined as a grid in the visual overlay. In some embodiments, the visual overlay may indicate the respective perturbation importance scores for each spatial region (e.g., by displaying the numerical perturbation scores inside the portions of the grid corresponding to the respective spatial regions).

The method 500 may proceed to step 524, wherein step 524 may include calculating, for each image in the set of one or more images, one or more respective feature importance scores. Feature importance scores may be based on perturbations applied to the image that caused misclassification. Exemplary feature importance scores may include edge importance scores or high frequency region importance scores. In some embodiments, method 500 may proceed directly to step 524 from step 516 without performing steps 518-522. In some embodiments, steps 524-526 may occur in parallel with steps 518-522.

In some embodiments, one or more feature importance scores may be calculated for each image in a set of one or more images. A feature importance score may be calculated for one or more spatial regions in an image, for one or more spatial regions present across a class of images, or for an entire image. To calculate a feature importance score for a spatial region of an image, a spatial region pixel mask for the spatial region may be generated. The spatial region pixel mask may isolate the spatial region (e.g., each pixel within the spatial region may be assigned a value of 1, and each pixel outside of the spatial region may be assigned a value of 0). A salience pixel mask may also be generated for the same spatial region. The salience pixel mask may be generated by calculating a value between 0 and 1 for each pixel within the spatial region based on the importance of the pixel with respect to the feature for which a feature importance score is being calculated, wherein a value of 1 indicates the pixel is highly important to accurate classification and a value of 0 indicates the pixel is of minimum importance. The two masks may then be combined, for example by performing a pixel-wise multiplication of the spatial region pixel mask and the salience pixel mask for the spatial region. The result may be normalized for each image in the set of one or more images. In some embodiments, one or more feature importance scores can be generated for one or more spatial regions present across a class of images. A feature importance score for a spatial region in a class of images may be calculated by calculating the average of the feature importance scores for the respective spatial region across all images assigned to the class by the baseline classification data. The feature importance score may optionally be normalized. In some embodiments, a feature importance score may be generated for an entire image by generating an image pixel mask for the entire image, generating a salience pixel mask for the entire image, and combining the image pixel mask and the salience pixel mask. An adjustment factor may be used to omit cases in which the salience pixel mask encompasses the entirety of the image. The adjustment factor may hedge the importance of a feature based on the relative prevalence of the feature in the image.

In some embodiments, a feature importance score may comprise a high frequency region importance score. For a given spatial region, a high frequency region importance score may be calculated by isolating high spatial frequency portions of the spatial region using one or more high pass filters and calculating a value between 0 and 1 for each pixel in the high spatial frequency portions based on the importance of the high spatial frequency portions to create a salience pixel mask, wherein a value of 1 indicates the pixel is highly important to classification accuracy and a value of 0 indicates the pixel is of minimum importance. The salience pixel mask may then be combined with a spatial region pixel mask to generate a high frequency region importance score for the spatial region. A high frequency region importance score may be calculated for an entire image by isolating high spatial frequency portions of the entire image using one or more high pass filters, calculating a value between 0 and 1 for each pixel in the high spatial frequency portions based on the intensity of the high spatial frequency portions to create a salience pixel mask, and combining the salience pixel mask with an image pixel mask to generate a high frequency region importance score. In some embodiments, a feature importance score may comprise an edge importance score. For a given spatial region, an edge importance score may be calculated by isolating edges in the spatial region using a Canny edge detector or a Sobel edge detector and blurring the edges using a low pass filter (e.g., a Gaussian filter) at various widths to determine the importance of the edges. A value between 0 and 1 may be calculated for each pixel corresponding to an edge based on the importance of the edge to create a salience pixel mask, wherein a value of 1 indicates the pixel is highly important to classification accuracy and a value of 0 indicates the pixel is of minimum importance. The salience pixel mask may be combined with a spatial region pixel mask to generate an edge importance score for the spatial region. An edge importance score may be calculated for an entire image by isolating the edges of the entire image using a Canny edge detector or a Sobel edge detector, blurring the edges using a low pass filter at various widths, calculating a value between 0 to 1 for each pixel corresponding to an edge based on the importance of the edge to create a salience pixel mask for the entire image, and combining the salience pixel mask with an image pixel mask.

After calculating one or more respective feature importance scores, the method 500 may proceed to step 526. Step 526 may comprise generating and displaying a histogram indicating, for each image in the first class, the one or more feature importance scores. In some embodiments, the histogram may comprise a plurality of bars corresponding to the one or more feature importance scores of each image in the set of images. Each image may be represented by one or more bars corresponding to the one or more feature importance scores calculated for that image. In some embodiments, each bar corresponding to a first feature importance score may be indicated by a first color, while each bar corresponding to a second feature importance score may be indicated by a second color. In some embodiments, hovering over a bar on the histogram with a cursor may display an indication of the respective numerical value of the feature importance score corresponding to the bar. The indication may also include the image corresponding to the bar.

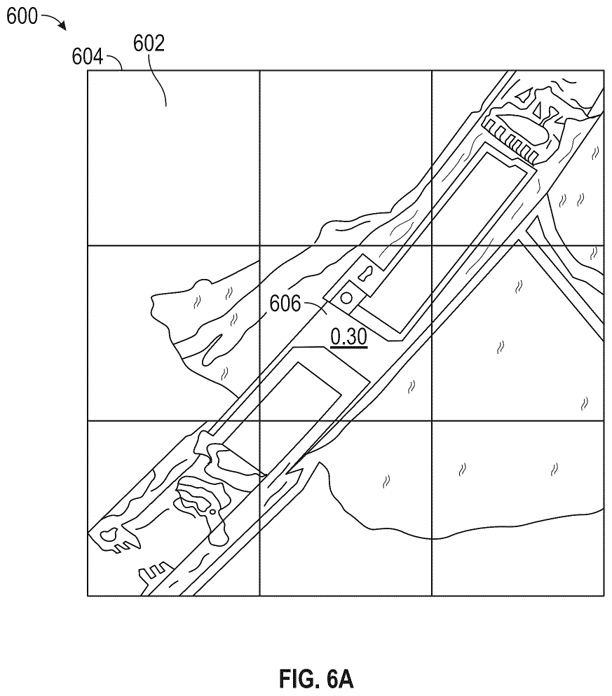

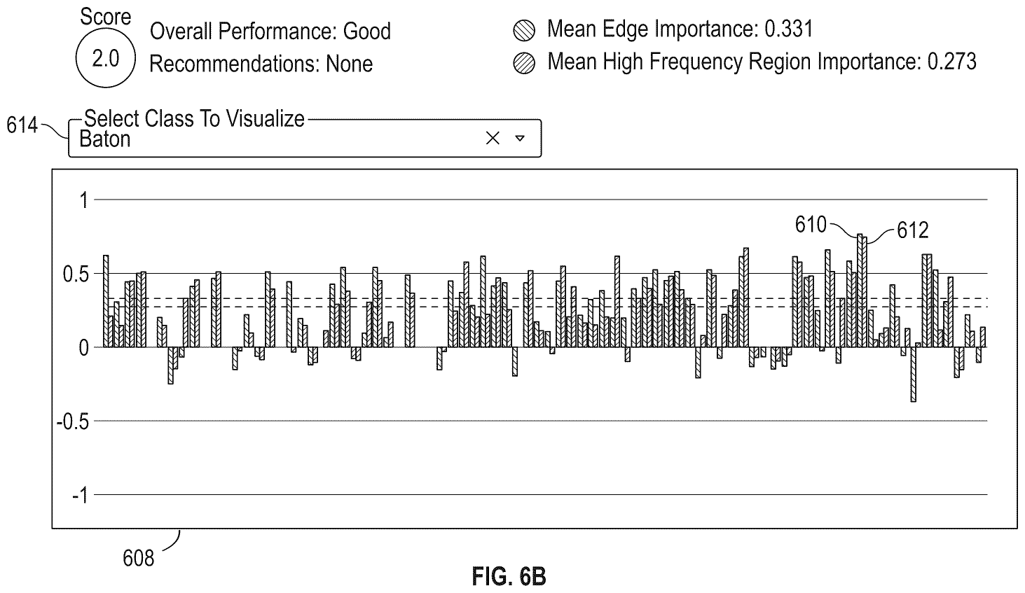

FIG. 6A illustrates a spatial region grid overlay 604 on an example image 600 from a class of images, according to some embodiments. As described above with reference to FIG. 5, a plurality of spatial regions may be defined for a set of one or more images assigned by the baseline classification data to a first class, and a respective perturbation importance score may be calculated for each spatial region. In some embodiments, one or more transformation operations (e.g., rotating, zooming in or out) may be applied to the one or more images to standardize one or more aspects of the images (e.g., orientation, size) before defining the spatial regions.

As shown in FIG. 6A, the plurality of spatial regions may be uniformly sized and shaped. For example, in FIG. 6A, each spatial region (e.g., spatial region 602) comprises a square with uniform dimensions. The boundaries of the spatial regions may be outlined and displayed as a grid overlay 604 on an example image 600 from the first class. Example image 600 may be any image selected from the first class. For instance, in FIG. 6A, example image 600 is an image of a baton from the set of images assigned by the baseline classification to the “baton” class, and the boundaries of spatial regions 602 are displayed as a grid overlay 604. As shown in FIG. 6A, a perturbation importance score 606 corresponding to a spatial region may be displayed within the appropriate spatial region. In some embodiments, perturbation score 606 may be displayed for a spatial region when a cursor is hovered over the spatial region.

FIG. 6B illustrates a histogram 608 indicating feature importance scores for a plurality of images in a class of images, according to some embodiments. In some embodiments, histogram 608 may be generated using method 500, as discussed above with reference to FIG. 5.

Histogram 608 may include a plurality of bars corresponding to one or more feature importance scores of one or more images in a selected class. For instance, in FIG. 6B, a first set of bars (e.g., bar 610) corresponds to a first feature importance score, wherein the first feature importance score is an edge importance score. A second set of bars (e.g., bar 612) corresponds to a second feature importance score, wherein the second feature importance score is a high frequency region importance score.

The feature importance scores displayed in histogram 608 correspond to images in a class of images that may be selected using class selection functionality 614. As shown in FIG. 6B, class selection functionality 614 may comprise a drop-down menu indicating the names of a plurality of classes of images. The drop-down menu may be configured to allow a user to select the name of a class and populate histogram 608 with the corresponding data for the selected class.

In some embodiments, additional information about trained model performance, such as one or more overall performance metrics or one or more recommendations to update the trained model, may be displayed with histogram 608. For instance, as shown in FIG. 6B, the trained model has received a numerical overall performance score of 2.0, a qualitative overall performance score of good, and a recommendation that no updates be made to the trained model.

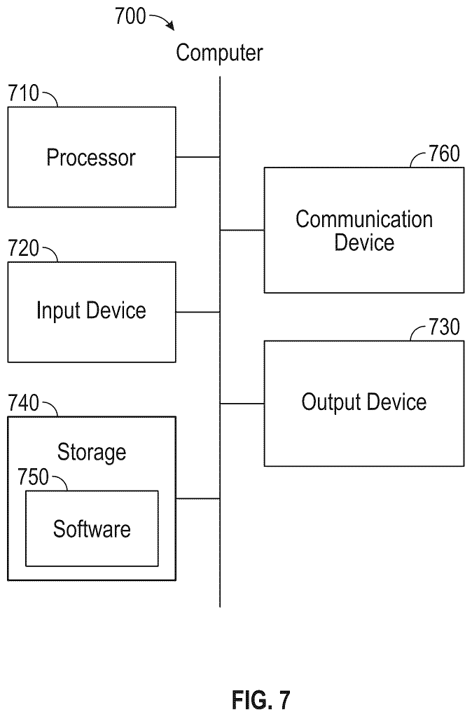

In one or more examples, the disclosed systems and methods utilize or may include a computer system. FIG. 7 illustrates an exemplary computing system according to one or more examples of the disclosure. Computer 700 can be a host computer connected to a network. Computer 700 can be a client computer or a server. As shown in FIG. 7, computer 700 can be any suitable type of microprocessor-based device, such as a personal computer, workstation, server, or handheld computing device, such as a phone or tablet. The computer can include, for example, one or more of processor 710, input device 720, output device 730, storage 740, and communication device 760. Input device 720 and output device 730 can correspond to those described above and can either be connectable or integrated with the computer.

Input device 720 can be any suitable device that provides input, such as a touch screen or monitor, keyboard, mouse, or voice-recognition device. Output device 730 can be any suitable device that provides an output, such as a touch screen, monitor, printer, disk drive, or speaker.

Storage 740 can be any suitable device that provides storage, such as an electrical, magnetic, or optical memory, including a random-access memory (RAM), cache, hard drive, CD-ROM drive, tape drive, or removable storage disk. Communication device 760 can include any suitable device capable of transmitting and receiving signals over a network, such as a network interface chip or card. The components of the computer can be connected in any suitable manner, such as via a physical bus or wirelessly. Storage 740 can be a non-transitory computer-readable storage medium comprising one or more programs, which, when executed by one or more processors, such as processor 710, cause the one or more processors to execute methods described herein.

Software 750, which can be stored in storage 740 and executed by processor 710, can include, for example, the programming that embodies the functionality of the present disclosure (e.g., as embodied in the systems, computers, servers, and/or devices as described above). In one or more examples, software 750 can include a combination of servers such as application servers and database servers.

Software 750 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A system for evaluating trained models, the system comprising one or more processors configured to cause the system to:
receive a trained model;
receive a set of test data comprising a plurality of data objects;
receive baseline classification data that assigns each data object to a class of a plurality of classes;
apply one or more perturbation operations to the test data to generate, for each of the data objects in the set of test data, a respective plurality of perturbed data objects;
apply the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification;
determine, for each of the perturbed data objects, whether the respective post-perturbation classification data indicates a misclassification as compared to the baseline classification data; and
generate and display a visualization based on the determination of whether the post-perturbation classification data indicates a misclassification.

2. The system of claim 1, wherein the one or more processors are configured to cause the system to generate, based on the determination of whether the post-perturbation classification data indicates a misclassification, one or more instructions to update the trained model.

3. The system of claim 2, wherein the one or more instructions to update the trained model comprise an indication to a user that the trained model has failed robustness criteria, an indication of improvements to make to the trained model, or an indication to automatically generate training data for improving the trained model.

4. The system of claim 2, wherein the one or more processors are configured to cause the system to execute the one or more instructions to update the trained model.

5. The system of claim 1, wherein the one or more processors are configured to cause the system to:
for the plurality of data objects assigned by the baseline classification data to a first class of the plurality of classes, wherein the plurality of data objects comprises a set of one or more images,
define a plurality of spatial regions in the one or more images;
calculate, for each spatial region, a respective perturbation importance score based on perturbations applied to the spatial region that caused misclassification;
display a visual representation of an example image from the first class; and
display a visual overlay over the example image indicating the perturbation importance score for one or more of the plurality of spatial regions.

6. The system of claim 5, wherein calculating, for each spatial region, a respective perturbation importance score comprises:
applying a Gaussian blur to the respective spatial region;
minimizing L2 Norm and total variational noise of perturbations applied to the respective spatial region; and
determining a minimum level of perturbation intensity that caused misclassification.

7. The system of claim 5, wherein the one or more processors are configured to cause the system to:
calculate, for each image in the set of one or more images, one or more respective feature importance scores based on perturbations applied to the image that changed one or more features of the image that caused misclassification; and
generate and display a histogram indicating, for each image in the first class, the one or more feature importance scores.

8. The system of claim 7, wherein calculating, for each image in the set of one or more images, one or more respective feature importance scores comprises:
generating an image pixel mask for the respective image;
generating a salience pixel mask for the respective image;
combining the image pixel mask and the salience pixel mask; and
calculating one or more feature importance scores based on the combined image pixel mask and salience pixel mask.

9. The system of claim 1, wherein the one or more processors are configured to cause the system to:
select a subset of post-perturbation classification data, wherein the subset of post-perturbation classification data corresponds to data objects assigned to a first class by the baseline classification data; and
generate and display a visual representation indicating average class confidence levels generated by the trained model for the selected subset of data at various levels of perturbation intensity.

10. The system of claim 9, wherein displaying the visual representation indicating average class confidence levels comprises displaying a first indication of a first average class confidence level by which the trained model classified the perturbed data objects into the first class.

11. The system of claim 10, wherein displaying the first indication comprises:
displaying a first region of the first indication at which average class confidence levels for the first class are highest compared to other classes; and
simultaneously displaying a second region of the first indication at which average class confidence levels for the first class are not highest compared to other classes.

12. The system of claim 9, wherein displaying the visual representation indicating average class confidence levels comprises displaying a second indication of a second average class confidence level by which the trained model classified the perturbed data objects into a second class different from the first class.

13. The system of claim 12, wherein the second indication is displayed for levels of perturbation intensity at which class confidence level for the second class is higher than for any other class.

14. The system of claim 9, wherein the visual representation comprises a first line graph indicating average class confidence levels generated by the trained model at various levels of perturbation intensity.

15. The system of claim 14, wherein the first line graph comprises one or more lines corresponding to one or more classes of the plurality of classes.

16. The system of claim 15, wherein the one or more processors are configured to cause the system to:
detect a user input comprising a selection of a first region visually indicating a first option to add to the first line graph one or more lines corresponding to one or more classes of the plurality of classes; and
in response to detecting the user input, add the one or more lines to the first line graph.

17. The system of claim 15, wherein the one or more processors are configured to cause the system to:
detect a user input comprising a selection of a second region visually indicating a second option to remove from the first line graph one or more lines corresponding to one or more classes of the plurality of classes; and
in response to detecting the user input, remove the one or more lines from the first line graph.

18. The system of claim 15, wherein the one or more processors are configured to cause the system to:
detect a user input comprising a selection of a region visually indicating a name of a class of the plurality of classes; and
in response to detecting the user input,
generate and display a second line graph indicating average class confidence levels of the trained model at various levels of perturbation intensity for the class; and
generate and display a third line graph indicating associated confidence levels of the trained model at various levels of perturbation intensity for at least one data object in the class.

19. A method for evaluating trained models, the method comprising:
receiving a trained model;
receiving a set of test data comprising a plurality of data objects;
receiving baseline classification data that assigns each data object to a class of a plurality of classes;
applying one or more perturbation operations to the test data to generate, for each of the data objects in the set of test data, a respective plurality of perturbed data objects;
applying the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification;
determining, for each of the perturbed data objects, whether the respective post-perturbation classification data indicates a misclassification as compared to the baseline classification data; and
generating and displaying a visualization based on the determination of whether the post-perturbation classification data indicates a misclassification.

20. A non-transitory computer readable storage medium storing instructions that, when executed by one or more processors of an electronic device, cause the device to:
receive a trained model;
receive a set of test data comprising a plurality of data objects;
receive baseline classification data that assigns each data object to a class of a plurality of classes;
apply one or more perturbation operations to the test data to generate, for each of the data objects in the set of test data, a respective plurality of perturbed data objects;
apply the trained model to each of the perturbed data objects to generate, for each of the perturbed data objects, respective post-perturbation classification data, wherein the respective post-perturbation classification data indicates classification of the respective perturbed data object into at least one of the plurality of classes and an associated confidence level of the trained model with respect to the classification;
determine, for each of the perturbed data objects, whether the respective post-perturbation classification data indicates a misclassification as compared to the baseline classification data; and
generate and display a visualization based on the determination of whether the post-perturbation classification data indicates a misclassification.
